(19) United States
(12) Patent Application Publication
(10) Pub. No.: US 2018/0137199 A1
(43) Pub. Date: May 17, 2018

(54) TARGETED COLLECTION AND STORAGE OF ONLINE SOCIAL NETWORK DATA IN EVIDENCE DOMAINS

(71) Applicant: SOCIAL EVIDENCE, LLC, Gainesville, FL (US)

(72) Inventors: KEVIN L MILLER, Gainesville, FL (US); JON MILLS, Gainesville, FL (US); WILLIAM F HAMILTON, Lithia, FL (US); ANDREW Z ADKINS, III, Gainesville, FL (US); GLENN STURM, Atlanta, GA (US); MARTHA BARNETT, Tallahassee, FL (US)

(21) Appl. No.: 15/814,713

(22) Filed: Nov. 16, 2017

Related U.S. Application Data
(60) Provisional application No. 62/423,473, filed on Nov. 17, 2016.

(51) Int. Cl. G06F 17/30; H04L 29/06; G06Q 50/00; H04L 29/08

(52) U.S. Cl. CPC G06F 17/30864; H04L 63/0884; H04L 63/302; H04L 67/306; H04L 63/308; G06Q 50/01

(57) ABSTRACT

Techniques and systems are provided for selecting, collecting, and storing online social network (OSN) data pertinent to an evidence context. A collection request with content filter parameters, an authentication mode, and a targeted OSN identity is received. A unique content and user perspective is determined to build an OSN connection that is used to asynchronously retrieve targeted OSN data entities in accordance with the content filter parameters. Filtered OSN data is assembled and stored in a modification-controlled repository. An integrity value for certifying the authenticity of stored OSN data is stored in an integrity value repository. Some implementations include methods for targeting information of evidentiary value by repeating a collection request at a timed interval and determining the existence of added, modified, or deleted OSN data from prior retrieval instances.

### CROSS-REFERENCE TO A RELATED APPLICATION

This application claims the benefit of U.S. provisional application Ser. No. 62/423,473, filed on Nov. 17, 2016, which is incorporated herein by reference in its entirety.

### BACKGROUND

Online Social Networks (OSNs) have revolutionized the way humans interact and drastically changed the landscape of communications and information sharing. Billions of OSN users share their personal status daily; they also post content containing text, photos, and videos, and repost, comment upon, and share their opinion about the content posted by others. While the primary reason to participate on OSNs, for users, may be to improve communication with others and become involved in an online community, the information shared on OSNs can be used for other purposes. Some examples of OSNs include Facebook®, Twitter®, Instagram®, Google+®, and LinkedIn®.

As OSNs have grown in popularity, they have come to possess an increasingly large percentage of the permanent record of communications between individuals and groups, as well as becoming a storage repository for the feelings, opinions, beliefs, thought processes, and even locations of the OSN user who posted the content. This diverse information has relevance in a wide variety of contexts that are mostly unrelated to the OSN users' original purpose in sharing the information. For instance, in the legal domain, information posted by OSN users is accepted as relevant for several uses, such as in litigation, where OSN information is both discoverable and admissible as evidence in an adjudicatory proceeding. In the health domain, the personal status information, feelings, and statements of OSN users can serve as valuable epidemiological and diagnostic evidence for researchers and physicians.

However, practitioners in these domains have found it difficult, due to the technical architecture of OSN services, to select, collect, and store OSN information in a manner that suits the use of the information as legal, scientific, or other evidence.

### BRIEF SUMMARY

Technical capabilities for selecting, collecting and storing information from an OSN related to an evidence context are currently severely limited by the traditional technical methods of interacting with OSNs. Techniques and systems are disclosed for selecting, collecting, and storing information from OSNs, such that targeting of information collection is improved and certified permanent storage suitable for evidentiary uses of the collected information is provided.

In an embodiment, techniques are provided for selecting, collecting, and certifiably storing OSN data targeted by a collection request pertinent to an evidence context. A collection request is received by a service or system implementing the disclosed techniques, for example, from an application, mobile “app”, web interface, or automated agent that operates to assist evidence analysis in a particular type of evidence domain (e.g., legal matters or litigation, healthcare, epidemiological research, human resources). The collection request has a unique identifier of a targeted OSN identity (e.g., a user account or other account type) on an OSN service. A collection request may specify collection filter parameters used, for instance, to target information by concepts in their content, by metadata properties such as time or location, and by type of content or data.

A collection request may also specify an authentication mode that directs the collection of OSN data to target a certain viewpoint, such as the “public” viewpoint of the OSN data of the OSN identity (e.g., what the public can see), or the viewpoint of the OSN data from the perspective of the OSN identity as itself (an “act-as-identity” viewpoint). Connection properties are determined from the authentication mode. This determination may include requesting, obtaining, or using a stored version of an access token—a public access token or an act-as-identity access token—as an aspect of the connection properties. In some implementations, a permissions protocol between a service, evidence analyst user or identity, and an OSN is used to obtain access authority for an act-as-identity access token for OSN data collection.

Using the connection properties and the collection filter parameters, OSN data is asynchronously retrieved from an OSN service. An asynchronous retrieval is a way of subdividing a collection request into multiple discrete requests that can be more effectively processed and that can be processed without the calling application or service having to wait for any request to complete before continuing. The caller that issued the collection request is notified when the OSN data from the request has been obtained and processed.

Some embodiments for performing the asynchronous retrieval include techniques for determining a data retrieval limit of a given connection to a particular OSN service and apportioning and scheduling the multiple discrete OSN data retrieval requests over a time period to fit within the retrieval limit of the utilized connection.

In some circumstances, OSN data may be manipulated—for instance, to align retrieved data with content filter parameters, a viewpoint/perspective of an access token, or other kinds of grouping, sorting, and additional content extraction or filtration—after OSN data has been retrieved but before a collection request is complete.

The data entities that an OSN returns do not necessarily contain information as it may be needed to satisfy the constraints of a given evidentiary domain—e.g., the information may be incomplete, contain inappropriate or unneeded OSN metadata, or structure information in an unusable form. Accordingly, for each OSN data entity in the OSN data entities retrieved by the asynchronous retrieval, a storage set of content and metadata of the OSN data entity is determined. The storage set is then stored in a modification-controlled repository that maintains strict control over the circumstances and users under which OSN data entities can be modified or deleted after they have been written. These techniques thereby make available a secure copy of important OSN data relevant to the evidence context, which can be important in evidence domains such as litigation and scientific research.

Further, an integrity value is computed on a hash set of content and metadata of the OSN data entity, and the integrity value is stored in an integrity value repository. These technical capabilities can be used to guarantee or certify that data has not been manipulated in the storage set after it was stored, regardless of the loss of the data on the OSN service.

According to certain embodiments, additional collections of a targeted collection request can be repeated on a time-defined or event-defined interval. The additional collection instances can retrieve additional OSN data according to the same collection filter parameters, but created since the last collection period. The additional collections may also re-collect OSN data from prior collections and compare the newly gathered OSN data to previously stored versions of OSN data to detect information that has been modified or deleted from its initial state.

This Brief Summary is provided to introduce a selection of concepts in a simplified form that are further described below in the Detailed Description. This Brief Summary is not intended to identify key features or essential features of the claimed subject matter, nor is it intended to be used to limit the scope of the claimed subject matter.

### BRIEF DESCRIPTION OF THE DRAWINGS

FIG. 1 shows an example component environment in which a system or service for facilitating the selection, collection, and storage of OSN data pertinent to an evidence context may be implemented.

FIG. 2 shows an example process flow for components implementing techniques for the selection, collection, and storage of OSN data pertinent to an evidence context.

FIG. 3 shows an example process flow for re-collecting OSN data related to a collection request and determining the existence of added, modified, and deleted OSN data.

FIG. 4 shows a block diagram illustrating components of a computing device or system used in some embodiments incorporating techniques and systems for facilitating the selection, collection, and storage of OSN data pertinent to an evidence context.

### DETAILED DESCRIPTION

Evidentiary information may be contained in both the content and the metadata of OSN data. “Content” typically is intended to mean those aspects of OSN data that have direct informational value to an application or person, such as the text of a post. “Metadata” generally refers to data about content or other data entities. Metadata generally directs a process to the location of data, or stores additional context information about the data, such as the last time it was updated. For example, the words in a simple text file are its content, but the “modified time” on the file is part of its metadata. For instance, if an OSN entity such as a post includes a digital photo, the content includes the photo itself and text the posting user typed in, whereas the metadata includes the posting time, geolocation of the user at the time the post was made, OSN-related identifiers, and other information.

Evidentiary information contained in content or metadata of OSN data may show, for example, knowledge or proof of facts or circumstances about which the OSN identity has knowledge. It may show an OSN user's sentiments or opinions about a concept as evidenced by overt expressions of feeling, emotion, or approval, such as through descriptive text in posts, comments to the posts of others, expressed sentiments or reactions about others' postings (such as when an OSN user clicks a “like” button or other sentiment indicator in a user interface). Evidence indicating an OSN user's relationships with others (as “friends”) may corroborate facts or familiarity indicating knowledge of character, habits, or other matters.

The kinds of evidentiary information needed from an OSN varies according to a number of factors which help to determine its “evidence context.” Factors present in an evidence context may, at least in part, be dependent on a knowledge domain or segmentation unit of a knowledge domain. These factors may influence the importance of certain concepts in the content of OSN data, the relevance or non-relevance of certain kinds of OSN metadata (such as the date and time of posting and location of posting), and the relevance of relationships between OSN data entities. For illustrative purposes, some examples are described below, but it should be noted that these examples are non-limiting.

For example, in a knowledge domain pertaining to legal matters or litigation, the knowledge domain itself (“legal matters”) may help to determine the presence, relevance, or non-relevance of certain factors in the evidence context. Litigation is an adversarial contest, generally between two or more parties, which may be individuals or groups of persons or other legal entities. The adversarial nature of litigation means that each party in a legal case attempts to provide information to an adjudicative entity that presents facts helpful to its case, or that erodes the helpfulness (e.g., relevance or credibility) of information presented by an opponent. Each party may rely upon factual information from numerous individuals, such as from factual witnesses and expert witnesses, as well as character information, testimony from character witnesses or rebuttal character witnesses, or character evidence such as evidence of habits. Each of these individuals or legal entities, from the parties themselves to the factual witnesses, character witnesses, and expert witnesses, may be associated with one or more OSN identity.

This cast of characters and their associated OSN identities may be determined, in part, by the legal knowledge domain itself and, in part, by the nature of the type of legal matter (e.g., wrongful termination litigation versus a felony criminal proceeding versus an immigration or asylum hearing). Procedural rules about types of content can influence the evidence context. For example, statements by a party in a case have different evidentiary positioning than the repeated statements of third parties (hearsay); furthermore, the procedural rules for evidence may vary according to the type of legal matter.

Furthermore, the type of legal matter and the nature of the issues at play in the case may define the set of concepts that are important to the evidence context. In a wrongful termination suit, for example, a terminated worker may assert that she was fired for reporting safety violations. One such violation caused her to severely injure her foot. A factor in the evidence context pertinent in this case, then, might include selecting OSN postings or data including a description or photo of her “injured foot.”

Factors in an evidence context, such as those described, may be implied by or embedded in an application, service, or system usage environment that supports a particular kind of knowledge domain. A service or application that facilitates defining the evidence context for the collection and storage of OSN data pertinent to legal cases, for example, may include implied factors that are different from those present in a service for defining a health diagnosis evidence context. For example, in a criminal case, the time and geolocation of a defendant's OSN postings around the time a crime was allegedly committed may be more important to the evidence context than any particular concept in the content of the posting; thus, the time and location of a crime may be implicitly part of the evidence context in a criminal matter. Moreover, in a health diagnosis domain, feelings of pain, injury, illness, or evidence of cancelling attendance at events or work expressed in posts likely predominate over concept or ideas expressed in the content of the posts, or their geolocation metadata.

Attorneys, physicians, researchers, human resources professionals, and others may need to select, collect, and store OSN data for evidentiary purposes. In some fields of use or knowledge domains (e.g., litigation, scientific research), the OSN data may need to be separately stored and certified against modification so that its evidentiary value is maintained. Operational scenarios may include applications on a traditional computing device (e.g., desktop or laptop computer), or a mobile device or smartphone “app”. For example, a user interface in an application may be generated on one of these devices that allows the setting of an evidence context through interaction with a device user or evidence analyst such as an attorney or physician. Another operational scenario also can be a data-gathering service to obtain OSN data for purposes such as scientific research, wherein the data-gathering service integrates with an evidence context collection and storage service described herein to collect and certify the OSN data.

Accordingly, techniques and systems are disclosed to allow the selection, collection, and storage of OSN data for evidentiary purposes. The techniques and systems disclosed solve at least several technical challenges inherent in interacting with OSNs using traditional means. First, the described techniques and systems target OSN data selectively, by providing for filtration of information by both content and metadata parameters. Second, they target OSN data by viewpoint, allowing selection of viewpoints ranging from a public user to an authorized user acting as the identity of the creator of the information. Third, they collect the targeted OSN data asynchronously by issuing a load-balanced and staged series of retrieval requests to the OSN. Fourth, in some implementations, they further enhance the asynchronous retrieval methods by determining a retrieval limitation of the OSN and staging retrieval requests so that they do not exceed the retrieval limitation. Fifth, the techniques and systems store a modification-controlled version of the OSN data, including both content and metadata, that may have been expanded, contracted, or otherwise manipulated from the OSN data that was originally gathered. Sixth, they maintain an integrity verification value on stored OSN data, so that the stored data may be certified in various legal or scientific evidentiary scenarios. Seventh, in some implementations, techniques and systems are presented for enhancing evidentiary content targeting by re-collecting certain data to determine when changes have been made to previously gathered content, which in some evidence contexts may be indicative of information having high evidentiary value.

In addition to these advantages, and aside from the improved usability, enhanced reliability, and reduced error rate experienced by users attempting to select, collect, and store evidentiary information from OSN data, additional technical effects and advantages are discussed with respect to particular technical features below.

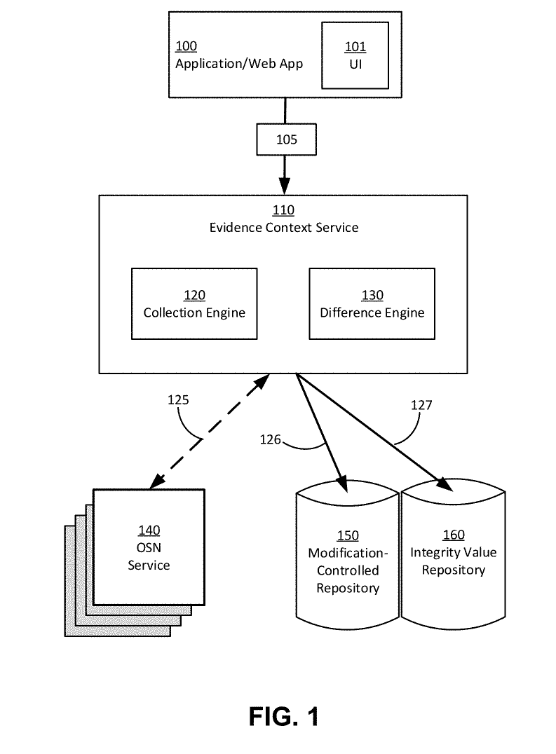

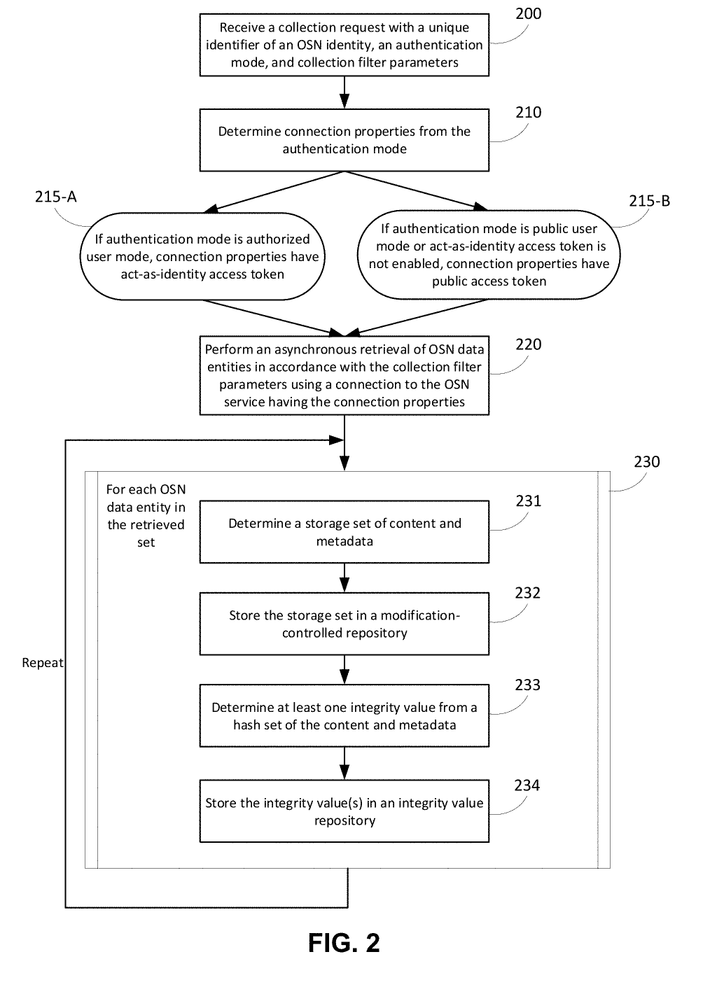

FIG. 1 shows an example component environment in which some implementations can be carried out. Briefly described here, and more fully described with respect to FIG. 2, an application, mobile app, or web browser interface provides a user interface for constructing and sending a collection request to a service/system (e.g., an “evidence context service”) implementing certain described techniques and systems. The collection request has information about a targeted selection of content and metadata to be retrieved from an OSN about a user identity on that OSN. The service includes a collection engine that implements a process flow for connecting to the OSN using a public or act-as-identity access token and asynchronously retrieving information via the connection in accordance with the content and metadata selection. The collection engine parses the returned information to determine a storage set and stores it in a modification-controlled repository. The collection engine also determines an integrity value from content and metadata selected from the retrieved information and stores the integrity value in an integrity value repository to serve as verification that the stored information has not been modified from its original form when downloaded from the OSN. It should be noted with respect to FIG. 1 that this summarized characterization is non-limiting and is provided for the purposes of understanding an example system environment from one perspective.

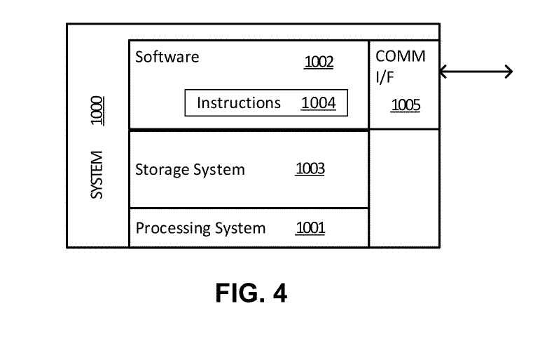

Referring to FIG. 1 in more detail, a user interface (UI) 101 of an application, mobile app, or web browser 100 may be rendered on a user device. In some cases, an application 100 can include an automated process without a user interface element. The user device may be, but is not limited to, a personal computer, a laptop computer, a desktop computer, a tablet computer, a reader, a mobile device, a personal digital assistant, a smart phone, a gaming device or console, a wearable computer with an optical head-mounted display, computer watch, or a smart television, of which computing system 1000, discussed below with respect to FIG. 4, is representative.

The application 100 may interact with an evidence context service 110 to send a collection request 105 over a network. The network can include, but is not limited to, a cellular network (e.g., wireless phone), a point-to-point dial up connection, a satellite network, the Internet, a local area network (LAN), a wide area network (WAN), a Wi-Fi network, an ad hoc network or a combination thereof. Such networks are widely used to connect various types of network elements, such as hubs, bridges, routers, switches, servers, and gateways. The network may include one or more connected networks (e.g., a multi-network environment) including public networks, such as the Internet, and/or private networks such as a secure enterprise private network. Access to the network may be provided via one or more wired or wireless access networks as will be understood by those skilled in the art.

Various types of physical or virtual computing systems may be used to implement the evidence context service 110, such as server computers, desktop computers, laptop computers, tablet computers, smart phones, or any other suitable computing appliance. When implemented using a server computer, any of a variety of servers may be used including, but not limited to, application servers, database servers, mail servers, rack servers, blade servers, tower servers, or any other type server, variation of server, or combination thereof.

In certain implementation, connections and communication between application 100 and evidence context service 110, as well as between evidence context service 110 and OSN service 140, are facilitated by an application programming interface (API) of the evidence context service 110 and/or the OSN service 140.

An API is generally a set of programming instructions and standards for enabling two or more applications to communicate with each other. An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API and related components may be stored in one or more computer readable storage media. An API is commonly implemented as a set of Hypertext Transfer Protocol (HTTP) request messages and a specified format or structure for response messages according to a REST (Representational state transfer) or SOAP (Simple Object Access Protocol) architecture.

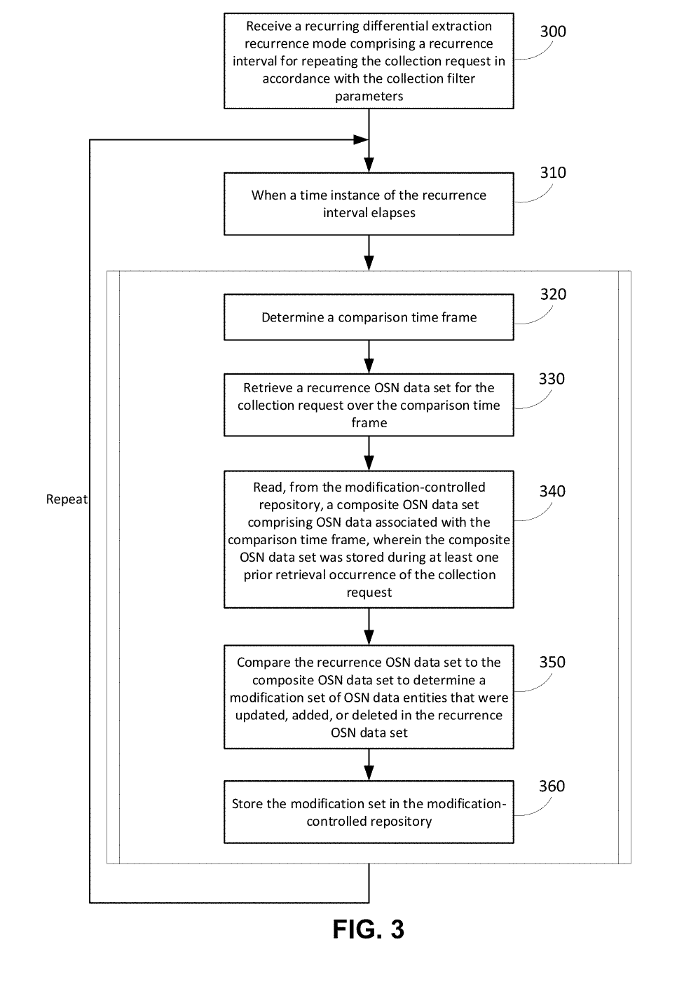

In response to receiving a collection request 105 from an application 100, the evidence context service 110 may initiate processing or delegate processing to additional components. In some implementations, the evidence context service 110 may have one or more additional components, such as a collection engine 120 and difference engine 130 (in some embodiments) to provide processing functions synchronously or asynchronously. Techniques and processes of a collection engine 120 and a difference engine 130 are described in more detail with respect to FIG. 2 and FIG. 3. Briefly, however, a collection engine 120 determines connection properties from information included with the collection request 105 and marshals a set of asynchronous retrieval requests 125 for OSN data which it sends to an OSN service 140. An OSN service 140 can be any online social networking service, including, for example, Facebook, Twitter, Linked In, Instagram, and Tumblr. Retrieval requests 125 may take varying forms, depending on the characteristics of the connected OSN service.

After receiving back OSN data from the OSN service 140, collection engine 120 can perform further processing on the OSN data to determine a storage set 126 of OSN data that is sent to a modification-controlled repository 150 in communication with the evidence context service 110. A modification-controlled repository 150 is stored on a computer-readable media as described with respect to FIG. 4. The characteristics of the modification-controlled repository are explored further in the text accompanying FIG. 2.

The collection engine 120 may also compute an integrity value for a hash set of the retrieved OSN data. The collection engine 120 sends the integrity value 127 to an integrity value repository 160, which may be maintained on a write-once-read-many computer-readable media. The stored integrity value enables verification of the storage set to ensure against intentional or unintentional modification of the storage set 126 in the modification-controlled repository 150. The characteristics of the integrity value repository 160 and integrity values are explored further in the text accompanying FIG. 2.

In some embodiments, a difference engine 130 may be present. A difference engine 130 may repeat certain collection requests periodically to determine whether data from a previous collection request instance has been added to or modified on an OSN service 140 since it was stored in the modification-controlled repository 150. The techniques and characteristics of a difference engine 130 are explored further in the text accompanying FIG. 3.

FIG. 2 illustrates an example process flow for collecting and storing OSN data pertinent to an evidence context. This example process flow illustrates technical features that overcome certain technical limitations of existing mechanisms for accessing, collecting, and storing OSN content and metadata. The disclosed techniques, illustrated in part by the example process flow of FIG. 2, improve upon the conventional technical operating principles of OSNs, thereby enabling OSN data to be collected and stored in a manner suited for evidence gathering and filtering using automated techniques. A process flow such as the example in FIG. 2 may be implemented in a system or service (e.g., evidence context service 110 of FIG. 1) for selecting, targeting, collecting, and storing OSN data pertinent to an evidence context.

In FIG. 2, a collection request is received (200) directing the selection of OSN data pertinent to an evidence context. A “collection request” is a software-based request received at a system or service that instructs the service to initiate OSN data selection, collection, storage, or related processes on a subset of the composite of available OSN data. The collection request may be generated in a variety of ways, including but not limited to resulting from a user's interaction with user interface elements of an application, web site, or mobile device “app”; the collection request can also be generated via automated processes resulting from automated agents (of the service or other third party services) executing periodically on a time schedule or in response to other triggering conditions. The collection request may be received by a system or service implementing the process flow via, for example, a function call or API call to the service.

The collection request may have a unique identifier that distinctly targets an OSN identity on the OSN service. The unique identifier describes a singular, one-to-one relationship with an OSN identity on the OSN. The unique identifier may also be referred to as a handle, username, user account, or account. A unique identifier may also include information such as an email address or telephone number that can be used to derive the unique identifier via a query of the OSN service. The syntax or form of the unique identifier may vary by the OSN service on which it is used. For example, a Facebook unique identifier has the form “username”, whereas a Twitter unique identifier takes the form of “@identity”. The form of the unique identifier also can include transformations of the unique identifier that are capable of use with an API of the OSN service. For example, a publicly known unique identifier may also be a proxy for an internally-assigned identifier of the OSN service which is used by the OSN for API calls.

This unique identifier may be used by a system or service implementing the described techniques to identify and target an OSN identity that helps describe a subset of the composite of available OSN data. The unique identifier may be used by the service to delimit the pertinent OSN data by, among other characteristics: authorship, creation, or modification of an OSN data entity by the OSN identity, an identity which is represented in the content of a OSN data entity; another kind of relation to an OSN data entity (e.g., a “like,” reply, repost, comment to, or other “share” of an OSN data entity by the OSN identity that was authored by another OSN identity); and a permissible viewpoint from which to view OSN data.

An “OSN data entity” includes any discrete unit of information provided by an OSN service, however structured. For example, an OSN data entity can be a post, comment, photo, video, an OSN user's profile, a security token, or any other packet or unit of information. Generally, but not always, an OSN data entity possesses composite information (e.g., fields) that describe content data, metadata, or relational attributes of the OSN data entity, such as the written text of a post, the creation time of the post, identifiers of other OSN identities that may be “tagged” or referred to in a photo in a post.

The collection request may have collection filter parameters that describe a subset of the composite of available OSN data in accordance with the evidence context. The collection filter parameters can be used by the service to identify and target certain content forming a subset of the totality of OSN data, for example by selecting a time range during which an OSN data entity was created, a topic of content contained in an OSN data entity, and/or an OSN entity type.

A non-limiting example of a collection filter parameter is a time range for selecting a set of OSN data entities by time metadata associated with each OSN data entity. For instance, the collection filter parameter could target the OSN data entities that have the metadata property of having been created during the time range spanning from “Jan. 1 to Mar. 31, 2005”. A collection filter parameter including time metadata can be selected by a user with elements, controls, or features of a user interface. For example, the applicable time range of the time metadata selection might be entered using a calendar control on a web form.

In some cases, the time range of a time metadata collection filter parameter is selected in accordance with an extended property of the evidence context. An extended property of the evidence context may be implied by and transmitted via an application or app developed for managing evidence in an evidence domain. For example, in an application that purports to use disclosed techniques to gather evidence OSNs for litigation, the application may structure the OSN identities into groupings associated with a court case. In this example, “cause of action” dates (e.g., date of injury) in an injury negligence case are a possible time metadata collection filter parameter implied by the evidence context. Also as an example, in an employment or human resources evidence domain, relevant dates may be the dates of employment at a prior enterprise.

A non-limiting example of a collection filter parameter is a search query for selecting a set of OSN data entities by content associated with the OSN data entity. For instance, the collection filter parameter could target OSN data entities that have textual description, photo captioning, or other written commentary with the words “foot,” “cat,” or the proper name of a person or workplace.

A non-limiting example of a collection filter parameter is an OSN data entity type parameter for selecting a set of OSN data entities by the entity type of the OSN data entity. For instance, the collection filter parameter might target only those OSN data entities that are “posts” or “messages” or “comments” or have “multimedia content.”

It should be noted that varying kinds of collection filter parameters can be combined to form composite collection filter parameters that target, for example, unions, intersections, or disjoint sets of collection. The components of the collection filter parameter can be joined, for example, by Boolean logical operators, relational or comparison operators, fuzzy logic operators, text-matching and text proximity operators, and other types of operators that might be found, for example, in a query language such as Structured Query Language (SQL) of a relational database system. As an example, the collection filter parameters might target “postings during Jan. 1-Mar. 31, 2005 that are not cat videos”.

In some cases, a service or system receiving the collection filter parameters (e.g., from one or more elements of a user interface) transforms the structure of the collection filter parameters into a query language form suitable for functioning with a particular database service or to a form compatible with the particular API of a targeted OSN service. For example, Facebook visualizes its data as a graph consisting of nodes (entities), edges (relationships), and information fields; Facebook provides programmatic access to these entities using its Graph API. Obtaining particular entities from Facebook requires the service or system to transform the collection filter parameters into a properly formed Graph API “GET” request. Alternatively, Twitter has a different API structure, and obtaining data from Twitter requires different transformations of the collection filter parameters.

A user interface for selecting or constructing collection filter parameters can take a variety of forms. For example, a user interface may provide interaction elements that enable a user to set collection filter parameters that are applicable to collection and storage of OSN data from one, or multiple, OSN services. In some instances, a user interface may allow user input into the construction of fewer than all of the collection filter parameters, while the system/service provides the remaining collection filter parameters as part of the evidence domain. For example, in the previous example of injury negligence litigation, an application may group OSN identity collection by case, and the OSN data from the date of the injury to the end of the litigation may be implicitly or automatically used by the application to define the collection filter parameters.

Sometimes, a targeted OSN service may lack the capability to process one or more of the collection filter parameters. For instance, this may occur when an OSN service does not expose interfaces to enable the selection of data according to a particular collection filter parameter. Additionally, it may occur when selecting the data would require the filtering of OSN entity sets in multiple stages.

Accordingly, in some implementations, the system or service may connect with the OSN service to obtain OSN data entities in accordance with fewer than all of the provided collection filter parameters. The system or service stores these OSN data entities in a temporary repository of the computer readable media so that the remaining collection filter parameters can be applied to the entities in the temporary repository. After applying the remaining collection filter parameters to derive the desired set of OSN data entities, the unutilized entities in the temporary repository can be securely discarded. These technical features represent an improvement in and a departure from technical capabilities traditionally provided by OSN APIs by enabling robust filtration of OSN data entities using collection filter parameters unavailable in OSN services. These technical features also represent an improvement in data security and user privacy because they only temporarily store working sets of data entities while they undergo final application of collection filter parameters, then securely dispose of unneeded data entities.

Returning to FIG. 2, connection properties for connecting to an OSN service are determined from the authentication mode (210). In some cases, the connection properties include an identity, account, or user perspective from which the data can be viewed and collected. In order to allow user or group privacy, some OSNs have restrictions on the visibility or availability of OSN posts, content, and other information. These access restrictions are, at least on some OSNs, defined by the user account associated with the connection making the request for information. Using the Facebook OSN as an example, a request to the Facebook Graph API to retrieve data needs to be authenticated with some user account identity. The posts and other content returned by Facebook in a Graph API request is selected from the perspective or viewpoint of what that user account is capable of viewing based on the user account's ownership of the content, its membership in groups, or its relationships with others based on “friendship” levels or other specific permissions granted by others. Thus, a Graph API request for content about “cats” might return all the “cat” posts by the user account identity that authenticated the request, as well as the posts of friends of that user account identity that are about “cats.” While the Facebook example is only illustrative, the Twitter OSN and LinkedIn OSN also provide methods by which requests for content are viewed from the perspective of the user identity associated with the request.

The aforementioned methods also serve to limit the content returned when a request is made for content about a user identity that is not the same as the OSN identity on which a request for content is made. Again using the Facebook OSN as an example, if a request for content about “cats” relating to USER1 is made via a connection authenticated by USER2, the Facebook Graph API will return only the USER1 “cat” posts that USER1 has designated as publicly viewable (unless USER1 has granted “friend” status or some other special permissions to USER2).

In accordance with the example process flow of FIG. 2, when a service or system receives a collection request, the collection request has an authentication mode identifying a perspective from which to select or collect OSN data from the OSN service. Using the authentication mode, connection properties are determined that are based on the selected viewpoint (public or act-as-identity) and the availability/enabling of an act-as-identity access token which allows the connection to the OSN to assume the authority to view data from the viewpoint of the OSN identity.

Sometimes, the authentication mode includes an authorized user mode (215-A). When the authentication mode designates an authorized user mode, the collection request pertains to collecting the OSN data entities from the perspective of the OSN identity. A connection may be formed which enables OSN data entities and/or their metadata to be visible or available from the perspective of the OSN identity. To form a connection in accordance with an authorized user mode, an enabled act-as-identity access token is included in the connection properties. An “act-as-identity access token” is a special data entity or programmatic identifier that an OSN service may issue when the credentials that secure a particular OSN identity from unauthorized access have been verified.

The form of the act-as-identity access token may be a simple string of numbers or characters that the OSN service uses as a key to an associated value in a key-value pair. The act-as-identity access token may also be a complex data object with multiple properties. The act-as-identity access token can be cryptographically signed in some circumstances.

An act-as-identity access token allows the system or service to make a request of the OSN service while acting as the user identity. The request may be made via an API of the OSN service, or sometimes via a user interface provided by the OSN service. In some cases, one or more additional requests can be made using the same access token.

In some cases, the act-as-identity access token may be available to the system or service. For instance, the system or service may have previously stored the act-as-identity access token after having received permission to do so from an OSN identity custodian.

In some cases, the act-as-identity access token from an OSN service can be stored and used repeatedly for a period of time. However, act-as-identity access tokens may expire after a time period (ranging from a few seconds to several months or a year) and require re-authorization of the credentials to receive a new act-as-identity access token.

To obtain or enable an act-as-identity access token, the system or service usually needs permission from an OSN user that is an owner, custodian or other credentialed agent of the OSN identity. In some cases, the act-as-identity access token is granted by the OSN service after a protocol of one or more stages for establishing permission has been fulfilled. Accordingly, certain implementations include techniques for receiving and enabling an act-as-identity access token from an OSN user associated with the desired OSN identity. A system or service implementing these techniques sends an access request notification that requests the enabling of the act-as-identity access token of the target OSN identity. The access request notification may be sent to the OSN user that is the account owner of the OSN identity, or to another OSN user who possesses the authority to grant the act-as-identity access token for the OSN identity. An access request notification can include, for example, a popup user interface, an email, text message, private social media message, or automated voice call. In some forms, the access request notification contains an embedded link that, when selected, directs the OSN user to an interface where the OSN user's credentials on the OSN service can be provided and verified.

Credentials can be provided and verified in various ways. A simple example is by providing a user interface for the entry of the OSN user's (e.g., OSN identity's owner or credentialed agent) username and password combination. The service or system sends the username and password combination via an API call to the OSN service, or via a user input element of a user interface to the OSN service. The OSN service checks the credentials and, if they match or authenticate, then the OSN service returns an act-as-identity access token to the calling system or service.

In some cases, the OSN service may itself provide the user interface elements for the entry of credentials in response to an API function call. For example, Facebook provides the OAUTH (and OAUTH2) APIs, which allow a system or service to request that the Facebook OSN conduct the complete credentials inquiry for the granting of an access token, including providing user interfaces for the entry of the username and password of the requested OSN user.

Additional types of credentials and verification methods include multi-factor authentication, wherein multiple stages using different methodologies must be completed before verification is complete. A biometric factor such as a fingerprint, retinal scan, or facial recognition, may also be used for credentialing. Essentially any challenge/response or identity system may be used for providing and verifying the OSN user's credentials and various methods may be combined. It should be noted that these are non-limiting examples of the kinds of credentials and verification methods an OSN service may use to authorize the issuance of an act-as-identity access token to a requestor.

In response to receiving an affirmative response to the access request notification, the system or service requesting the enabled act-as-identity access token receives it from the OSN service. The access token may then be stored or used to determine connection properties for a connection from that OSN identity's viewpoint.

In some cases, the credentials verification process for an act-as-identity access token may allow or require the OSN user to make additional refinements to the content viewpoint. For instance, in some cases and on some OSN services, the OSN user can select which types of activities are possible using the act-as-identity access token. These selections/refinements may make certain content of the OSN identity (or of associated OSN identities, such as “friends”) viewable or unviewable, or provide limitations on the ability to retrieve certain metadata (such as geolocation) from content types.

A request for OSN data that is not authenticated by any user or account identity, but is “public,” can be made via a connection to some kinds of OSN services. The returned content will only be of content designated by the poster to be publicly viewable. In some cases the authentication mode includes a “public user mode,” indicating that the perspective from which to select or collect OSN data is that of an unauthenticated identity or an authenticated identity that is not the OSN identity specified by the unique identifier. The connection is then initiated with connection properties that include a “public access token” (215-B). The public access token, in this context, may be a token provided by the OSN service which allows connections to be made to the OSN service free of any credentials verification. The public access token may also be issued for an OSN identity that belongs to a service, system, or app (such as the one implementing the described techniques) initiating the connection in accordance with the connection properties. This public access token may be called a “developer key” by some OSN services.

Some OSN services may have the capability to authenticate a connection with a user identity but designate the request to return only content from the public viewpoint, regardless of the visibility provided by the user identity; however, other OSNs may not have such a capability.

Accordingly, in some circumstances, a service or system implementing the techniques herein may retrieve OSN data entities from an OSN identity using an act-as-identity access token, but perform further filtering processes on the retrieved data to match the viewpoint indicated by the public user mode. In an example process flow for implementing this technical capability, the system or service may review metadata associated with a returned or retrieved OSN data entity that indicates the privacy status of the OSN data entity. Metadata of the OSN data entity that indicates membership in a private or restricted-access group, or other privacy or permissions settings, may indicate the OSN data entity is not visible to a public viewpoint. The system or service may in that case remove the private OSN data entity from the one or more OSN data entities to receive further processing or storage. This may be done, for example, to technically enable an evidence context that includes only information that is publicly available or known, a feature which may be useful in some evidence domains.

Returning now to FIG. 2, having determined the connection properties, a connection to the OSN service can be initiated. In some cases, depending on OSN service parameters, a connection is initiated by issuing a request to the OSN service, for example, via an API call to the OSN service. In some cases, the request may result in a temporary connection token that can be used for a period to make additional calls to the OSN service using the same connection. Alternatively, the connection and the retrieval request might be part of same API call. For example, a stored public or act-as-identity access token may be used in conjunction with a retrieval request for particular OSN data.

OSN data entities are asynchronously retrieved from the OSN service via the connection in accordance with the collection filter parameter (220). An “asynchronous” retrieval (or operation, function, or mode) of OSN data entities can be distinguished from a synchronous retrieval or operation. In a synchronous operation, the instructions of the operation execute in a serial progression, where each instruction is completely performed prior to continuing to the next instruction or function. For example, in a synchronous operation, when an instruction in function A performs a function B (such as issuing a retrieval request), function A waits for function B to complete the entirety of its instructions before function A continues with the instruction after the call to function B. In contrast, an asynchronous operation is characterized by return of control to the caller before the full scope of the operation has been completed. For example, if function B is an asynchronous operation, function B immediately returns control to function A, even though function B may merely initiate the process of performing its work. In many implementations, an asynchronous operation may be performed by initiating an additional “thread” of execution according to existing mechanisms provided by the operating system. Further, in many instances, an asynchronous function has a paired notification mechanism (e.g., a “callback function” or event sender/event sink) for informing the calling process of the occurrence of intermediate or concluding activities, such as that the initiated operation has completed successfully or has failed.

Some OSN services may allow a single OSN call to be issued asynchronously under certain conditions. Returned data of the call may in those cases be received piecemeal, arriving as the OSN service has time to fulfill them over potentially high-latency networks. Such a mechanism might, for example, be used when a retrieval request returns a large amount of content (e.g., “all posts during 2012”). In large returns of content, an OSN service may “cursor” the data so that the OSN data may be retrieved asynchronously and incrementally by the calling system or service. In some cases, the individual OSN data entities may contain a large amount of data, such that an individual OSN data entity needs to be paginated or traversed with cursors.

The asynchronous retrieval is also performed in accordance with the collection filter parameters. As discussed elsewhere, collection filter parameters can be used to make additional refinements on the constituents of sets of OSN data entities returned during the retrieval process, for example, by selecting time ranges for events or metadata, OSN data entity types, or the subject matter of content present or described in the OSN data entity. As noted, these collection filter parameters may be applied, for example, by transforming the collection filter parameter as received by the system or service into query instructions transmittable to the OSN service via, e.g., an API call to the OSN service. For example, if collection filter parameters specify that only photos belonging to a particular Facebook user are desired, then, when connected with the act-as-identity access token of the user's OSN identity on Facebook, the system or service might send the following command using Facebook's Graph API: “GET graph.facebook.com/me/photos”.

Specific sets of data or metadata may also be specified by collection filter parameters and transformed into applicable OSN API commands. For example, if only particular profile information (e.g., name and profile photo) about a Facebook user is desired, then, when connected with the act-as-identity access token of the user's OSN identity on Facebook, the system or service might send the following command using Facebook's Graph API: “GET graph.facebook.com/me?fields=name, picture”.

Collecting and storing OSN data pertinent to an evidence context may require querying, retrieving, and selecting large amounts of OSN data. However, some OSN services may limit or cap the amount of OSN data that can be retrieved over a certain time period. For example, an OSN service may enforce limits on the number of OSN data entities retrieved or the number of requests that can be made over a given time period. An OSN service may also enforce limitations on the quantity of data (e.g., the number of bytes) returned in response to any given retrieval request or group of retrieval requests. In response to a request that exceeds the cap or limit, an OSN service could, for example, return an error message or merely truncate the data without warning. Furthermore, these limits may differ in accordance with the nature of the connection; for example, a retrieval request issued over a connection made with connection properties including an act-as-identity access token may have different limits or caps than a connection using a public access token. These data caps can moderately or severely limit the collecting and storing of OSN data pertinent to an evidence context.

Techniques are presented for solving these and other problems with the design and functioning of OSN services, creating technical advantages over existing functions of OSN services. In conjunction with technical features for processing asynchronous retrievals, and in accordance with some implementations of a system or service utilizing the described techniques, an asynchronous retrieval may be performed, in part, by performing connection-based apportioning and scheduling of the asynchronous retrieval into multiple OSN data entity retrieval requests.

Initially, a per-time-unit data retrieval limit of the connection to the OSN service is determined. Various methods may be used for determining the data retrieval limit of the connection. In cases where the connection utilizes an access token that has not been used before, the data retrieval limit may be determined by metering the time elapsed and the amount of data (e.g., volume in bytes or in a count of data entities) that was returned before an error message was received or a data truncation occurred. Deriving the per-time-unit data retrieval limit may be performed preemptively by sending one or more sampling requests for an OSN identity's data entities that is not necessarily ranged by the collection filter parameters of the collection request. For example, a system or service implementing these techniques may issue a sampling request against a known return set of OSN data entities to gauge the amount of data per request or per time period.

In some embodiments, once the data retrieval limit has been determined, it can be stored in a computer-readable media of the system or service as an attribute of the OSN service type, a connection property of the OSN service or the authentication mode type, or as an attribute of that OSN identity's access tokens specifically. Storing the data retrieval limit has the advantage of allowing it to be reused in later asynchronous retrieval operations without repeating a sampling request.

Once the per-time-unit data retrieval limit is known, a system or service implementing these techniques can use them to apportion and schedule a set of OSN data entity retrieval requests over a particular time interval to remain within the data retrieval limit. This has the technical effect of avoiding error messages, avoiding data retrieval due to truncation by unknown or unwanted data limits or caps, and even avoiding connection termination by an OSN service due to terms of service violations. Apportioning the asynchronous retrieval allows a system or service implementing these techniques to deconstruct a single request to an OSN service into two or more retrieval requests that return an amount of data that fits within the per-time-unit data retrieval limit. For example, while it may be technically possible to retrieve all of an OSN identity's posts of “photos” using a single HTTP get request, the nature of the OSN's data caps may make it impossible to actually receive all the data without receiving a warning or data truncation. The service may instead apportion the single request into multiple requests targeting a smaller time range, e.g., based on creation date of the post. These multiple requests may then be scheduled so that they are issued over a time interval (e.g., one request per minute) so that retrieval limits for the connection to the OSN service are not exceeded.

It should be noted that methods for apportioning and scheduling retrieval requests over a time period may have additional technical advantages and effects that arise independently of whether an OSN service implements data caps. For example, a system or service may use these methods to schedule work during times of reduced OSN service or system component workload, or to take advantage of lower processing costs on shared cloud service computing models. In some cases, methods of apportioning and scheduling a set of OSN data entity retrieval requests may be used to span multiple collection requests.

As the one or more OSN data entities are asynchronously retrieved from the OSN service via the connection, the OSN data may be returned in a variety of forms. In many cases, if the retrieval requests are sent over an HTTP-based API of the OSN service, the OSN will return the data in a JSON (JavaScript Object Notation) format, which is an open standard format using simply-structured text to transmit data objects consisting of attribute-value pairs. Other formats for data return include XML (eXtended Markup Language) and YAML (Yet Another Markup Language). In some cases, the OSN returns the data as a page readable by a web browser client, formatted, for example, as HTML or other markup. A system or service may need to perform additional processing to determine data objects from data formatted in this way. The format returned will largely depend on the format used by the OSN service. The JSON text or other format containing the returned data can then be processed and transformed by the system or service as required.

As described, in some cases the retrieved OSN data may need further culling, sorting, or reduction as a result of the need to modify a viewpoint to match an authentication mode (e.g., modify a friend or act-as-identity access token's viewpoint to a public user mode viewpoint), or as a result of the need to make final refinements of the returned OSN data entities to match a collection filter. Accordingly, some implementations may include a retrieval set preprocessor to review the initially returned OSN data entities and remove unneeded OSN data entities. A preprocessor may, for example: read the JSON returned to determine whether a “post time” metadata field in the JSON fits within the parameters of the collection filter and, if not, discard it; or read the JSON returned to determine whether a security or privacy attribute of the OSN data entity indicates that the data is not viewable to the general public, and, if so, discard it. These are merely examples of the kinds of preprocessing performed by a system or service implementing these techniques to transform a retrieval set into a final form in accordance with the collection filter parameters and authentication mode viewpoint.

Returning to the example process flow of FIG. 2, several activities are performed with respect to each OSN data entity obtained during the asynchronous retrieval process (230). Initially, a storage set of content and metadata of the OSN entity is determined (231). The storage set of content and metadata of the OSN entity contains the content and metadata that is pertinent to the evidence context.

In some circumstances and in accordance with the functioning of any given OSN service, certain content or metadata may need additional processing as part of determining the storage set. This additional processing can include additional data retrieval requests from the OSN service, either through an API of the OSN service or via other methods, such as direct HTTP/HTTPS transfer. For example, when a call is made via the Facebook Graph API for photos, it returns JSON describing metadata relating to the posting of the photo, but not the actual content of the photo (i.e., not an image file or other object with the photo itself). Instead, Facebook returns a textual URL in the “picture” field of the returned JSON for the photo OSN data entity. Accordingly, in order to retrieve the photo itself, a system or service implementing these techniques may make a second request using the photo URL to obtain the actual file (e.g., “.jpeg” or other image file format) that contains the photo's content. The same processing may be needed for video, audio, or other kinds of file postings, postings containing embedded URLs to other content, and so on.

In some cases, relational attributes—e.g., fields that relate the OSN data entity to a second OSN data entity, such as another post, a comment, or a second OSN identity—may also need to be unpacked by making additional OSN service requests to obtain those second OSN data entities. For example, if the retrieval set includes a post that is a “repost” of an original post by a different OSN user, then an additional OSN service request to retrieve the OSN data entity of the original post may be used. Or, if a particular OSN user is “tagged” in a photo of a post, an additional request to retrieve the OSN data entities for the tagged user's OSN profile may be issued.

The content and metadata derived from these additional processing activities may then be included in the storage set of content and metadata for that OSN data entity. In order to be usable for an evidence context, content and metadata is collected (and stored) in its complete form; this avoids the consequences of OSN data relevant to an evidence context being unavailable in the future as a result of an OSN service becoming unavailable, a privacy setting being changed, or accidental or intentional removal of the OSN data. This technical feature of determining a storage set for each OSN data entity thus represents a technical effect or advantage over merely linking to existing content stored on OSN services.

It may not be necessary or desirable to store all content and metadata of an OSN data entity. Therefore, removal of unnecessary or undesired content and/or metadata from the storage set an OSN data entity may be appropriate. For instance, a call via the Facebook Graph API may return JSON having internal linking or other metadata associated with the OSN data entity. An example of such unnecessary metadata are the paging cursors that assist a Graph API calling application in navigating a large result set of data by creating internal references to the prior and next pages of data. Since these paging cursors are generally applicable only to the current API request and are invalid after a time, they can be eliminated from the storage set. It should be noted that this is merely an example and that removal of undesired content and/or metadata from a storage set will depend on factors such as the evidence context, collection filter parameters, and the specific functionality of the connected OSN service.

Returning to FIG. 2, when a storage set of content and metadata has been determined for the OSN data entity, the storage set is stored in a modification-controlled repository (232). A modification-controlled repository can be stored on a computer-readable media accessible by a system or service implementing described techniques.

A repository for the storage set of content and metadata can take many forms, depending on the amount to be stored, scalability needs, and the need for future filtering of the OSN data by evidence context. Structuring techniques for a repository can range from highly-ordered organizations of information—where each data element has a place in a rigidly defined structure—to loose collections of unstructured data. Highly-ordered information collections may be managed by relational database management systems (RDBMS), which have the advantages of fast indexing and transactional integrity on changes to data.

In some cases, flexible collections of unstructured data can be advantageous because they lack a centralized indexing hierarchy such as may become a processing bottleneck in an RDBMS. These more unstructured methods of repository management are sometimes referred to as non-relational, or “NoSQL” databases. One of the simplest forms of a non-relational database uses “documents” or files in the file system to serve as a data store. The “database” merely consists of a collection of such store files, many of which may refer to binary objects. A document or file loosely corresponds to a record in an RDBMS table, but contains data which is far less structured in many cases.

In the very simplest document-oriented non-relational databases, the referencing-content and metadata store documents/files are merely placed in directories. The file system itself manages the index based on the unique name given to each document, and no other overarching database management system is present. In one environment of this kind, a collection of XML, HTML, or JSON files contain the content and metadata in the repository. Any or all of the individual files might refer to one or more binary objects located in the same or other storage localities or systems. These binary objects might themselves be files containing a representation of data in a standardized format, for example, an image file or photograph, or a multimedia file with video and/or sound recordings.

In some cases, a repository may be structured as a loose hybrid of file/NoSQL and RDBMS models, in which some aspects of the storage set of content and metadata is stored in files managed by a directory service, and other aspects are stored in the RDBMS as highly-indexed content or metadata. In a preferred implementation of a repository for storing OSN data relevant to an evidence context, an RDBMS stores certain highly used content (e.g., the post description) and metadata (e.g., OSN identity unique identifier, the creation date of the post). This kind of hybrid model allows stored information to be quickly found later by keying on certain indexed data. The RDBMS also stores key-value pairs, one of which may indicate a file that has some or all of the raw JSON for the OSN data entity originally retrieved from the OSN service; other key-value pairs may reference content more effectively stored in a file store (e.g., the .jpeg file containing a photo that was posted). When an OSN data entity is later retrieved from the hybrid repository, content and metadata from the various stores is assembled and presented for review.

An aspect of the repository that makes it suitable for storage of OSN data relating to an evidence context is that the repository is “modification-controlled”. A modification-controlled repository is one in which a storage set, once written, is unable to be, or rarely able to be, modified. Modification controls may be implemented on a repository in a variety of ways. For instance, some RDBMSs allow fine-grained access controls to be placed on database tables and fields so that only specific administrative processes can delete or modify the RDBMS records or fields. A file/directory system also can have access controls that allow certain processing entities to create files, but not to modify or delete them. In some cases, a particular type of computer-readable media may not permit modification of data once the data is written to the repository. This type of computer-readable media may be referred to as “write-once-read-many” (WORM) media, of which one example is an optical disc.

In a preferred embodiment of a secure repository using a hybrid model of NoSQL and RDBMS structures, modification controls would be placed on both the RDBMS-stored content and metadata, as well as on the files stored in the directory system. Access controls to create, but not to modify or delete, data would be assigned to system or service processes that store the storage set. Access controls to delete data would be assigned only to system or service processes that remove storage set data as part of a cleanup or archiving process when the evidence context for the OSN data entities is no longer applicable. In some cases, the JSON of the storage set, or the OSN data entity in its entirety, may be modification-controlled in a file/directory system, while some or all of the RDBMS indexing metadata may not be modification-controlled.

Data integrity verification is a technical feature of these techniques making them suitable for storage of OSN data relating to an evidence context. An “integrity hash value” is computed and permanently stored on certain stored content and metadata to be used as external verification of data integrity. Data integrity verification may be relevant to data in some evidence contexts, e.g., those applicable to evidence in litigation or other kinds of records compliance.

One or more integrity value may be computed or determined from a hash set of content and metadata of the OSN data entity (233). An integrity value may be calculated using a hash function, which is any function that can be used to map data of an arbitrary size to a value having a fixed length or size. For instance, a hash function can take as input a series of bytes in a data file or text file, and output a unique “message digest,” or string, that represents the contents of the file. This string is of a fixed length (between 128 and 256 bits in usual methods), so that the contents of any size of file will be “reduced” to a unique message digest of a particular size. If a single character or byte of the file is modified or deleted, the hash function will compute a different message digest the next time it is run. The characteristics of hash functions make them usable as integrity values, since any change to a file is indicated by comparing a previously stored version of the integrity value to a version of the integrity value computed when examining or using the data. Examples of hash functions suitable for integrity values include MD5, SHA1, or SHA2.

A hash set of content and metadata is a subset or superset of content and metadata of the OSN data entity, and may also include the content and metadata of OSN data entities described in relational attributes. It may also include individual content items stored separately but referenced by OSN data entities, such as files containing photos, videos, or audio (e.g., jpegs, gifs, MP3s, MP4s).

The content and metadata in the hash set may differ from the entirety of OSN data entity content and metadata. For instance, it may be desirable, based on an evidence context, to only compute an integrity value on certain aspects of the information returned in an OSN data entity. Sometimes, the content and metadata in the hash set may be different from that of the storage set, as sometimes it may useful to be able to examine certain information even though the information does not need to be certified for integrity. For example, a hash set could include content and metadata relating to a photo/image file, posting date, and posting description, but not content or metadata relating to comments or likes that may change frequently and dynamically over time, but that may be stored in the storage set. In some cases, more than one integrity value may be computed on different partitions of the hash set; for example, a first integrity value may be computed and maintained for the content and metadata relating to a “post” OSN data entity, and a second integrity value may be computed and maintained for the content of an image file referred to in the post that was unpacked during determination of the storage set.

One or more integrity value is computed on the hash set of content and metadata at the time an OSN data entity is retrieved and stored from the OSN service in accordance with techniques herein. An integrity value may then be stored in an integrity value repository (234) so that later, when the data is reviewed, a system or service can certify the integrity of the value by comparing the integrity value stored on the computer-readable-media to a dynamic integrity value computed on the same data at the time of viewing. If the stored integrity value and the dynamic integrity value are the same, the OSN data entity remains valid for use in an evidence context, but if they are not the same, the OSN data entity has been modified and it is no longer valid for use. An integrity value repository may be implemented, for instance, on a write-once-read-many (WORM) type of computer-readable media.

Some embodiments may include techniques or interfaces for comparing a stored integrity value to a dynamic integrity value. For example, when a OSN data entity is presented for viewing in a user interface element of an application, mobile app, or web interface, an interface element may compute a dynamic integrity value on the currently presented information. Proximate to the information, the user interface may display the integrity value stored in the integrity value repository and the dynamic integrity value so that the user can compare the values. In some cases, a user interface element may show an indicator highlighting or emphasizing a mismatch between the values. In some embodiments, integrity values may be stored on individual content items of an OSN entity and multiple dynamic integrity values may be computed and displayed with indicators. For example, the post description and metadata may have one integrity value and a content item such as a photo may have another integrity value.

The evidentiary value of OSN information in certain kinds of evidence contexts may be improved by special selection and filtration of OSN data entities that were added to, or modified/deleted from, a previously stored set of OSN data. For instance, in legal or litigation-related evidence contexts, OSN data which an OSN identity (e.g., a party or witness in the case) tried to remove or modify subsequently can have high evidentiary value. Take a simple example in which a person sues a neighbor, believing that the neighbor has given her cat a poisoned treat. When the initial legal complaint is filed, the OSN data of the neighbor is collected by the plaintiff's attorney; the OSN data includes some posts by the neighbor stating: “I hate dirty feral cats.” A subsequent re-collection of the neighbor's OSN data two weeks later shows that the neighbor removed the cat posts. The plaintiff's attorney would likely find the fact that these posts were removed by the neighbor to be highly probative.

Accordingly these techniques enable them to be highlighted from among what may otherwise be a large amount of uninteresting social media postings. However, existing OSN technologies lack the technical capabilities for targeting deleted or modified OSN data. Accordingly, technical features for recurring differential extraction and comparison of OSN data entities are provided to advantageously overcome the shortcomings in existing OSNs.

FIG. 3 shows an example process flow for re-collecting OSN data related to a collection request and determining the existence of added, modified, and deleted OSN data. A process flow like that in FIG. 3 may be implemented, for example, by a difference engine as described in FIG. 1.

Initially, a recurring differential extraction recurrence mode is received indicating a recurrence interval or event for repeating a collection request in accordance with the collection filter parameters (300). A “recurring differential extraction” recurrence mode indicates parameters and conditions under which a particular collection request is rerun one or more additional times to determine if any OSN data gathered during the original collection request has been modified, removed, or appended to.

One kind of parameter or condition of a recurring differential extraction recurrence mode is a recurrence interval for repeating the collection request at a given time interval or at the passing of an event. For example, a recurrence interval could indicate that a collection request be repeated every hour, day, week, or month; or a recurrence interval event might indicate that the collection request be repeated at a given event, such as the end of the discovery period in litigation. Another kind of parameter or condition could be an expiration time or event for terminating the recurrence at a future date and/or time. An expiration time or event parameter might also specify that the recurrence terminates at the happening of an “event” associated with the evidence context, e.g., when a legal case is closed or when a jury trial is over.

In some circumstances, a parameter or condition of the recurring differential extraction recurrence mode may indicate a type of differential extraction mode. One kind of differential extraction mode indicates that OSN data should be re-collected only over the same time period indicated by a collection filter parameter specifying a time range for selecting OSN data entities by time metadata. For example, a collection request indicating posts with “cat” by the neighbor during January-February 2016 would be re-executed repeatedly on the recurrence interval.

Another kind of differential extraction mode may indicate that OSN data should be re-collected over the same time period as the original collection filter parameter, but also that new OSN data added during the recurrence interval should likewise be collected. In this kind of differential extraction mode, the additive portion of the collection request may be re-run only in accordance with the collection filter parameters that do not specify creation-time-related metadata. In this kind of differential extraction mode, for example, a collection request indicating posts with “cat” by the neighbor during January-February 2016 might be set to repeat on recurrence interval of two weeks. As each interval elapses, the January-February 2016 collection request would repeat for the purpose of comparing for modifications and deletions; also, any new OSN data with “cat” that appears during the during the two week time frame of the recurrence interval would be added to the modification set. In some cases, as each interval elapses, any new material added may also enlarge the comparison time frame for re-collecting to discover modifications and deletions.

In another kind of differential extraction mode, only new OSN data added during the recurrence interval is collected, again in accordance with only those collection filter parameters that do not target time-related metadata. Following the previous examples, only new data with “cat” would be added to the modification set, and the January-February 2016 collection request would not be re-executed.

Properties and conditions of a recurring differential extraction recurrence mode may be implicitly part of an evidence context, or may be communicated through the evidence context by an application, app, or service. In some cases, the properties and conditions may be set by an evidence analyst using a user interface of an application, app, or service.

When a time instance of the recurrence interval elapses (e.g., every two week period) (310), a comparison time frame is determined in view of the kind of differential extraction mode indicated (320). Depending on the differential extraction mode type, the comparison time frame indicates a time period for re-collection of OSN data over an initial collection filter parameter and including OSN data added subsequently due to the elapsing of additional recurrence intervals. The comparison time frame may also indicate a time period for the collection of new data over the time range of the recurrence interval.

A recurrence OSN data set is retrieved for the collection request over the comparison time frame (330). A recurrence OSN data set may be retrieved similarly to the manner in which the original, first collection request was performed. For example, the same authentication mode, access tokens, OSN identity characteristics, and even all or some of the same collection filter parameters may be used. The recurrence OSN data set may also be retrieved asynchronously.

A composite OSN data set may now be read from the modification-controlled repository (340). The composite OSN data set includes OSN data that is associated with the comparison time frame and may include OSN data that was stored during one or more prior retrieval occurrences. Continuing with the previous example, if the collection request pertaining to “cat” had a recurring differential extraction recurrence mode including a two week recurrence interval and a differential extraction mode for adding new data and reviewing previously collected data for modifications and deletions, then a composite OSN data set would contain OSN data stored during the original collection request for January-February 2016, as well as subsequently added or new data over each two week recurrence interval.

The recurrence OSN data set and the composite OSN data set are then compared to determine a modification set of OSN data entities that were added to, or were updated in or deleted from, the recurrence OSN data set (350). The modification set may attach indicators or metadata that indicate an OSN data entity was newly added during the recurrence interval. The modification set may also attach indicators or metadata to indicate an OSN data entity in the composite OSN data set was deleted or modified during the recurrence interval. These indicators may be used to call out newly added data for special review or attention in a processing task or in a user interface viewed by an evidence analyst. In the case of an OSN data entity with a modification indicator, one or more revisions of an OSN data entity may be retained in the modification set. A user interface may be rendered to show a side-by-side comparison of the modified information, which may have evidentiary value in addition to the fact of its modification. In the case of an OSN data entity with a deletion indicator, the OSN data entity in the composite OSN data set may be placed in the modification set along with additional metadata indicating the time period during which the OSN data entity was subsequently deleted.

The modification set may then be stored in the modification-controlled repository (360) using similar techniques to those described in FIG. 2 for storage sets.

In some implementations, comparing the recurrence OSN data set to the composite OSN data set comprises a comparison of a stored integrity value for each stored OSN data entity in the composite OSN data set with a computed comparison integrity value on a matching OSN data entity in the recurrence OSN data set.

For each stored OSN data entity in the composite OSN data set, the stored integrity value is read from the integrity value repository. The recurrence OSN data set is then searched for in a matching OSN data entity present in the recurrence OSN data set. A search may be performed, for example, using a stored version of OSN data entity identifier provided by the OSN service in the metadata of the OSN data entity. If a matching OSN data entity is found, a comparison integrity value may be computed on the matching OSN data entity in the recurrence data set. The comparison integrity value may then be compared to the stored integrity value and, if they do not match, the matching OSN data entity is added to the modification set, for example, with a modification indicator as described above. If the comparison integrity value matches the stored integrity value, no activity may be performed or, in some cases, the matching OSN data entity is removed from the recurrence OSN data set.

If the matching OSN data entity is not found, the stored OSN data entity may be added to the modification set as a deleted OSN data entity, for example, with a deletion indicator and associated deletion time period metadata.

FIG. 4 shows a block diagram illustrating components of a computing device or system used in some implementations of techniques, systems, or services for facilitating the selection, collection, and storage of OSN data pertinent to an evidence context. For example, any component of the system, including an evidence context service, collection engine, difference engine, application/web app, modification controlled-repository, and integrity value repository may be implemented on one or more systems as described with respect to system 1000. System 1000 can itself include one or more computing systems or devices. The hardware can be configured according to any suitable computer architectures such as a Symmetric Multi-Processing (SMP) architecture or a Non-Uniform Memory Access (NUMA) architecture.

The system 1000 can include a processing system 1001, which may include a processing device such as a central processing unit (CPU) or microprocessor and other circuitry that retrieves and executes software 1002 from storage system 1003. Processing system 1001 may be implemented within a single processing device but may also be distributed across multiple processing devices or sub-systems that cooperate in executing program instructions.

Examples of processing system 1001 include general purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general purpose CPU.

Storage system 1003 may comprise any computer-readable storage media readable by processing system 1001 and capable of storing software 1002 including, e.g., processing instructions, for facilitating the selection, collection, and storage of OSN data pertinent to an evidence context. Storage system 1003 may include volatile and nonvolatile, removable and non-removable media implemented in any method or technology for storage of information, such as computer readable instructions, data structures, program modules, or other data.

Examples of storage media include random access memory (RAM), read only memory (ROM), magnetic disks, optical disks, write-once-read-many disks, CDs, DVDs, flash memory, solid state memory, phase change memory, 3D-XPoint memory, or any other suitable storage media. Certain implementations may involve either or both virtual memory and non-virtual memory. In no case do storage media consist of a transitory propagated signal. In addition to storage media, in some implementations, storage system 1003 may also include communication media over which software 1002 may be communicated internally or externally.

Storage system 1003 may be implemented as a single storage device but may also be implemented across multiple storage devices or sub-systems co-located or distributed relative to each other. Storage system 1003 may include additional elements capable of communicating with processing system 1001.

Software 1002 may be implemented in program instructions and, among other functions, may, when executed by system 1000 in general or processing system 1001 in particular, direct system 1000 or processing system 1001 to operate as described herein for facilitating the selection, collection, and storage of OSN data pertinent to an evidence context. Software 1002 may provide program instructions 1004 that implement components for facilitating the selection, collection, and storage of OSN data pertinent to an evidence context. Software 1002 may implement on system 1000 components, programs, agents, or layers that implement in machine-readable processing instructions 1004 the methods and techniques described herein.

In general, software 1002 may, when loaded into processing system 1001 and executed, transform system 1000 overall from a general-purpose computing system into a special-purpose computing system customized to select, collect, and store of OSN data pertinent to an evidence context in accordance with the techniques herein. Indeed, encoding software 1002 on storage system 1003 may transform the physical structure of storage system 1003. The specific transformation of the physical structure may depend on various factors in different implementations of this description. Examples of such factors may include, but are not limited to, the technology used to implement the storage media of storage system 1003 and whether the computer-storage media are characterized as primary or secondary storage. Software 1002 may also include firmware or some other form of machine-readable processing instructions executable by processing system 1001. Software 1002 may also include additional processes, programs, or components, such as operating system software and other application software.

System 1000 may represent any computing system on which software 1002 may be staged and from where software 1002 may be distributed, transported, downloaded, or otherwise provided to yet another computing system for deployment and execution, or yet additional distribution. System 1000 may also represent other computing systems that may form a necessary or optional part of an operating environment for the disclosed techniques and systems, e.g., repositories or OSN services.

A communication interface 1005 may be included, providing communication connections and devices that allow for communication between system 1000 and other computing systems (not shown) over a communication network or collection of networks (not shown) or the air. Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned communication media, network, connections, and devices are well known and need not be discussed at length here.

It should be noted that many elements of system 1000 may be included in a system-on-a-chip (SoC) device. These elements may include, but are not limited to, the processing system 1001, a communications interface 1005, and even elements of the storage system 1003 and software 1002.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

It should be understood that the examples and embodiments described herein are for illustrative purposes only and that various modifications or changes in light thereof will be suggested to persons skilled in the art and are to be included within the spirit and purview of this application.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method of facilitating collection and storage of online social network (OSN) data pertinent to an evidence context, the method comprising:
receiving a collection request comprising a unique identifier of an OSN identity of an OSN service, an authentication mode, and collection filter parameters;
determining connection properties from the authentication mode, wherein the connection properties include an act-as-identity access token of the OSN identity when the authentication mode includes an authorized user mode and the act-as-identity access token is enabled for the OSN identity, wherein the connection properties include a public access token when the authentication mode includes a public user mode or when the act-as-identity access token is not enabled for the OSN identity;
performing an asynchronous retrieval, via a connection to the OSN service using the connection properties, of one or more OSN data entities in accordance with the collection filter parameters; and
for each OSN data entity of the one or more OSN data entities retrieved:
determining a storage set of content and metadata of the OSN data entity;
storing the storage set of content and metadata of the OSN data entity in a modification-controlled repository;
determining at least one integrity value from a hash set of content and metadata of the OSN data entity; and
storing the at least one integrity value in an integrity value repository.

2. The method of claim 1, wherein the OSN data entity comprises one or more of:
profile content of the OSN identity or of a second OSN identity, wherein the second OSN identity is accessible via the act-as-identity access token of the OSN identity or the public access token;
profile metadata of the OSN identity or of the second OSN identity;
posting content of the OSN identity or of the second OSN identity;
posting metadata of the OSN identity or of the second OSN identity;
a relational attribute relating the OSN data entity to a second OSN data entity or to the second OSN identity;
a privacy attribute of the OSN identity or of the second OSN identity; and
a security attribute of the OSN identity or of the second OSN identity.

3. The method of claim 1, wherein the collection filter parameters comprise one or more of:
a time range for selecting a first set of OSN data entities by a time metadata associated with each OSN data entity;
a search query for selecting a second set of OSN data entities by content associated with each OSN data entity; and
an OSN data entity type parameter for selecting a third set of OSN data entities by an entity type associated with each OSN data entity.

4. The method of claim 1, further comprising, prior to determining the connection properties from the authentication mode:
sending, to an OSN user associated with the OSN identity, an access request notification that requests the enabling of the act-as-identity access token of the OSN identity; and
in response to receiving, from the OSN user, an affirmative response to the access request notification, receiving an enabled act-as-identity access token from the OSN service.

5. The method of claim 1, wherein performing the asynchronous retrieval of the one or more OSN data entities further comprises:
determining a per-time-unit data retrieval limit of the connection to the OSN service; and
apportioning and scheduling a set of OSN data entity retrieval requests over a particular time interval to remain within the per-time-unit data retrieval limit of the connection.

6. The method of claim 1, further comprising:
receiving a recurring differential extraction recurrence mode comprising a recurrence interval for repeating the collection request in accordance with the collection filter parameters; and
when a time instance of the recurrence interval elapses:
determining a comparison time frame;
retrieving a recurrence OSN data set for the collection request over the comparison time frame;
reading, from the modification-controlled repository, a composite OSN data set comprising OSN data associated with the comparison time frame, wherein the composite OSN data set was stored during at least one prior retrieval occurrence of the collection request;
comparing the recurrence OSN data set to the composite OSN data set to determine a modification set of OSN data entities that were updated, added, or deleted in the recurrence OSN data set; and
storing the modification set in the modification-controlled repository.

7. The method of claim 6, wherein comparing the recurrence OSN data set to the composite OSN data set comprises, for each stored OSN data entity in the composite OSN data set:
retrieving a stored integrity value for the stored OSN data entity from the integrity value repository;
searching the recurrence OSN data set for a matching OSN data entity;
when the matching OSN data entity is found, generating a comparison integrity value for the matching OSN data entity in the recurrence OSN data set, and, when the stored integrity value and the comparison integrity value do not match, adding the matching OSN data entity to the modification set as a modified OSN data entity; and
when the matching OSN data entity is not found, adding the stored OSN data entity to the modification set as a deleted OSN data entity.

8. A service for facilitating collection and storage of online social network (OSN) data pertinent to an evidence context, the service comprising:
one or more computer-readable storage media;
a processing system;
program instructions stored on at least one of the one or more computer readable storage media that, when executed by the processing system, direct the processing system to:
in response to receiving a collection request comprising a unique identifier of an OSN identity of an OSN service, an authentication mode, and collection filter parameters:
determine connection properties from the authentication mode, wherein the connection properties include an act-as-identity access token of the OSN identity when the authentication mode includes an authorized user mode and the act-as-identity access token is enabled for the OSN identity, wherein the connection properties include a public access token when the authentication mode includes a public user mode or when the act-as-identity access token is not enabled for the OSN identity;
perform an asynchronous retrieval, via a connection to the OSN service using the connection properties, of one or more OSN data entities in accordance with the collection filter parameters;
in response to completion of the asynchronous retrieval for a received OSN data entity of the one or more OSN data entities:
determine a storage set of content and metadata of the OSN data entity;
store the storage set of content and metadata of the OSN data entity in a modification-controlled repository of at least one of the one or more computer-readable media;
determine at least one integrity value from a hash set of content and metadata of the OSN data entity; and
store the at least one integrity value in an integrity value repository of at least one of the one or more computer-readable media; and
sending a notification of the completion of the asynchronous retrieval.

9. The service of claim 8, wherein the OSN data entity comprises one or more of:
profile content of the OSN identity or of a second OSN identity, wherein the second OSN identity is accessible via the act-as-identity access token of the OSN identity or the public access token;
profile metadata of the OSN identity or of the second OSN identity;
posting content of the OSN identity or of the second OSN identity;
posting metadata of the OSN identity or of the second OSN identity;
a relational attribute relating the OSN data entity to a second OSN data entity or to the second OSN identity;
a privacy attribute of the OSN identity or of the second OSN identity; and
a security attribute of the OSN identity or of the second OSN identity.

10. The service of claim 8, wherein the collection filter parameters comprise one or more of:
a time range for selecting a first set of OSN data entities by a time metadata associated with each OSN data entity;
a search query for selecting a second set of OSN data entities by content associated with each OSN data entity; and
an OSN data entity type parameter for selecting a third set of OSN data entities by an entity type associated with each OSN data entity.

11. The service of claim 8, further comprising program instructions that, when executed by the processing system, direct the processing system to, prior to determining the connection properties from the authentication mode:
send, to an OSN user associated with the OSN identity, an access request notification that requests the enabling of the act-as-identity access token of the OSN identity; and
in response to receiving, from the OSN user, an affirmative response to the access request notification, receive an enabled act-as-identity access token from the OSN service.

12. The service of claim 8, wherein the program instructions that direct the processing system to perform the asynchronous retrieval of the one or more OSN data entities further comprise program instructions that direct the processing system to:
determine a per-time-unit data retrieval limit of the connection to the OSN service; and
apportion and schedule a set of OSN data entity retrieval requests over a particular time interval to remain within the per-time-unit data retrieval limit of the connection.

13. The service of claim 8, further comprising program instructions for a difference engine that, when executed by the processing system, direct the processing system to:
in response to receiving a recurring differential extraction recurrence mode comprising a recurrence interval for repeating the collection request in accordance with the collection filter parameters:
wait for a time instance of the recurrence interval to elapse; and
in response to the elapsing of the time instance of the recurrence interval:
determine a comparison time frame;
retrieve a recurrence OSN data set for the collection request over the comparison time frame;
read, from the modification-controlled repository, a composite OSN data set comprising OSN data associated with the comparison time frame, wherein the composite OSN data set was stored during at least one prior retrieval occurrence of the collection request;
compare the recurrence OSN data set to the composite OSN data set to determine a modification set of OSN data entities that were updated, added, or deleted in the recurrence OSN data set; and
store the modification set in the modification-controlled repository.

14. The service of claim 13, wherein the program instructions that direct the processing system to compare the recurrence OSN data set to the composite OSN data set direct the processing system to:
for each stored OSN data entity in the composite OSN data set:
retrieve a stored integrity value for the stored OSN data entity from the integrity value repository;
search the recurrence OSN data set for a matching OSN data entity;
when the matching OSN data entity is found, generate a comparison integrity value for the matching OSN data entity in the recurrence OSN data set, and, when the stored integrity value and the comparison integrity value do not match, add the matching OSN data entity to the modification set as a modified OSN data entity; and
when the matching OSN data entity is not found, add the stored OSN data entity to the modification set as a deleted OSN data entity.
